(19) United States
(12) Patent Application Publication
(10) Pub. No.: US 2011/0012540 A1
(43) Pub. Date: Jan. 20, 2011

(54) Multipurpose flame light

(75) Inventors: Charles Lan, Dongguan Cigy (CN); John Liu, Dongguan City (CN)

Correspondence Address: BACON & THOMAS, PLLC, 625 SLATERS LANE, FOURTH FLOOR, ALEXANDRIA, VA, 22314-1176, US

(73) Assignee: Superiorlite Corporation Limited, Dongguan City (CN)

(21) Appl. No.: 12/458,615

(22) Filed: Jul. 17, 2009

(51) Int. Cl. H05B 37/00

(52) U.S. Cl. 315/320

(57) ABSTRACT

A multipurpose flame light is disclosed, which is made up of a body and an ON-OFF control unit, where the body is formed by a lighting module of a neat and ordered array of multiple LED lamps and an actuator for offering stable electric voltage and current to the lighting module. The body is provided with a base at its bottom and a wire slot at its one side, where the base is further provided with a control system in it, which comprises a memory and a CPU. The ON-OFF control unit is connected to the control system through a data line passing through the wire slot. And the ON-OFF control unit further comprises an on-off switch and a fine-tuning switch. By turning the on-off switch, the lighting module, controlled by the control system, is switched between flame-light mode and illumination-light mode, and by turning the fine-tuning switch, the multiple LED lamps of the lighting module is being controlled by the control system to execute various lightening sequences that are programmed beforehand or to adjust the intended luminance.

### BACKGROUND OF THE INVENTION

1. Field of the Invention

This invention relates generally to multipurpose flame lights and more specifically to one that is handy in switching between flame-light mode and illumination-light mode, and available in choosing various lightening sequences that is programmed beforehand and in adjusting intended luminance.

2. Description of the Prior Art

A practical electric lamp is developed by Thomas Edison in 1879, which is the electric lighting that contributed the most to mankind. For a century of using electric lamps, human society has made colossal progresses. Science and technology also changed swiftly. With the desire for quality life, a lot of electric lightings of different illumination mechanisms are invented, where LED lamp is the focus among all. It features advantages as stable illumination, low power consumption, relatively tiny in volume, etc. Therefore, as the LED gained its public awareness, novel electric lightings made up of different ratios of LED lamps to other parts are almost countless in the market. For instance: U.S. Pat. No. 6,688,752, CHINA Utility Model No. 200520054947.7, 200520062769.2, 200520064552.5 and 200620112416.3, are made up of multiple LED lamps and other parts to form examples of flame light. However, the efforts that the aforesaid prior art stressed are either in the novelty of control mechanism or in the look of enhancing flame.

The flame light is an existing product. However, manufacturers design and produce it based on a single purpose of using as a flame light only. The approach doesn't go against the basic purpose though; the use at any rate is sizably limited at all. Therefore, this inventor conceived the idea of the design for novelty, to augment the multiple uses of the flame light.

### SUMMARY OF THE INVENTION

The objective of this invention is to provide a multipurpose flame light, which is handy in switching between flame-light mode and illumination-light mode.

The other objective of this invention is to provide a multipurpose flame light, which is available in choosing various lightening sequences that is programmed beforehand or capable in adjusting intended luminance.

To achieve the aforementioned objects, this invention offers a multipurpose flame light, made up of a body and an ON-OFF control unit, where the body is formed by a lighting module of a neat and ordered array of multiple LED lamps and an actuator for offering stable electric voltage and current to the lighting module. And the body is provided with a base at its bottom and a wire slot at its one side, where the base is further provided with a control system inside it, which comprises a memory and a CPU. The ON-OFF control unit is connected to the control system through a data line passing through the wire slot. And the ON-OFF control unit further comprises an on-off switch and a fine-tuning switch. By turning the on-off switch, the lighting module is controlled by the control system to switch between flame-light mode and illumination-light mode. And by turning the fine-tuning switch, the multiple LED lamps of the lighting module are controlled by the control system to execute various lightening sequences that are programmed beforehand or to adjust the intended luminance.

In this invention, by turning the on-off switch, the lighting module is controlled by the control system to switch between flame-light mode and illumination-light mode, where the program for using as flame-light mode or the program for using as illumination-light mode is stored in the memory. Therefore, by turning the on-off switch, a selection to access the program for using as flame-light mode or the program for using as illumination-light mode is executed. And further processed by the CPU, the lighting module on the body lightens according to the commands of the stored programs.

In this invention, by turning the fine-tuning switch, the multiple LED lamps of the lighting module are controlled by the control system to execute various lightening sequences that are programmed beforehand or to adjust the intended luminance, where the programs of various flame shapes in the flame-light mode are stored in the memory. Therefore, by turning the fine-tuning switch, a selection to access the program of the intended flame shape in the flame-light mode is executed. And further processed by the CPU, the lighting module on the body lightens according to the lightening sequence in the program of various flame shapes and to the intended luminance.

In this invention, the base extends downward and a tie-in is set up on it.

In this invention, the tie-in is a threaded one, for threaded connection with a lamp holder.

In this invention, the tie-in is a shaft one, for getting stuck with a lamp holder.

### BRIEF DESCRIPTION OF THE DRAWINGS

FIG. 1 is an exterior structural view of the first embodiment of this invention;

FIG. 2 is a cross sectional view of the first embodiment of this invention;

FIG. 3 is a longitudinal sectional view of the first embodiment of this invention;

FIG. 4 is an exterior structural view of the second embodiment of this invention;

FIG. 5 is a longitudinal sectional view of the second embodiment of this invention;

FIG. 6 is a circuit diagram of the embodiment of this invention; and

FIG. 7 is a block diagram of the use of the embodiment of this invention.

### DETAILED DESCRIPTION OF THE INVENTION

To achieve the foregoing objects of the present invention, the techniques adopted and the achievable function are detailed described with reference to the following preferred exemplified embodiments and the accompanying drawings for a thorough comprehension.

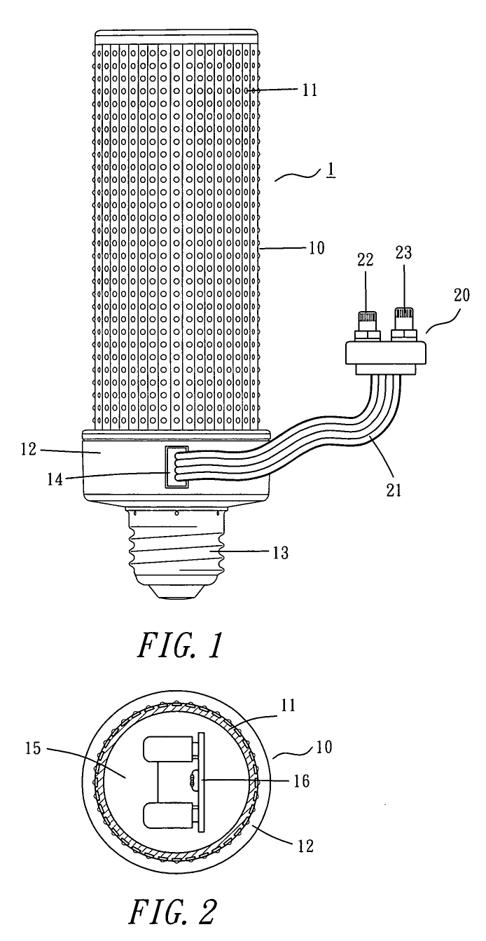

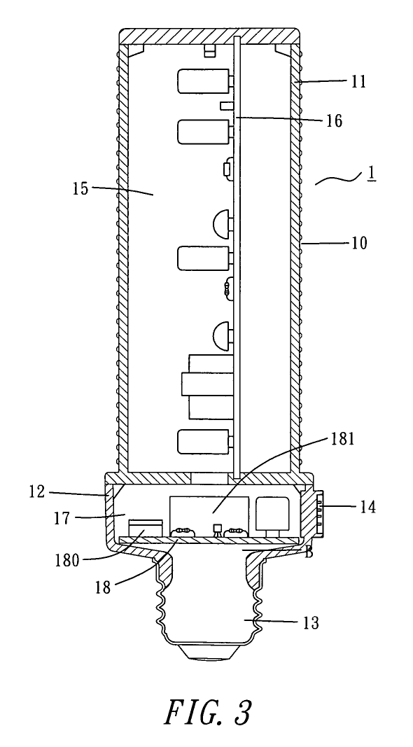

The first exemplary embodiment of this invention as a whole is a multipurpose flame light, referring to FIGS. 1-3, and the flame light 1 comprises a body 10 and an ON-OFF control unit 20, where a lighting module 11 is on its outside, which is formed by a neat and ordered array of multiple LED lamps. And the ordered array is not limited in its shape, for instance: cylinder, cone, prism, pyramid, ball, many-faceted solid, tower, etc. The lighting module 11 is provided with a base 12 at its bottom, which extends downward to form a threaded tie-in 13, for the threaded connection with a lamp holder (not shown), and the base 12 is provided with a wire slot 14 at its one side. The body 10 has a lodging space 15, for the lodging of an actuator 16, which is to offer stable electric voltage and current (the actuator 16 can be placed outside of the body 10 for actual implementation) to the lighting module 11. The base 12 forms another lodging space 17, for the lodging of a control system 18, which is made up of a memory 180, a CPU 181 connected to the memory 180 and some electric circuits used for the connection. The control system 18 is connected to the actuator 16 through the wire slot 14. The ON-OFF control unit 20 is connected to the CPU 181 through a data line 21 passing through the wire slot 14. And the ON-OFF control unit 20 further comprises an on-off switch 22 and a fine-tuning switch 23.

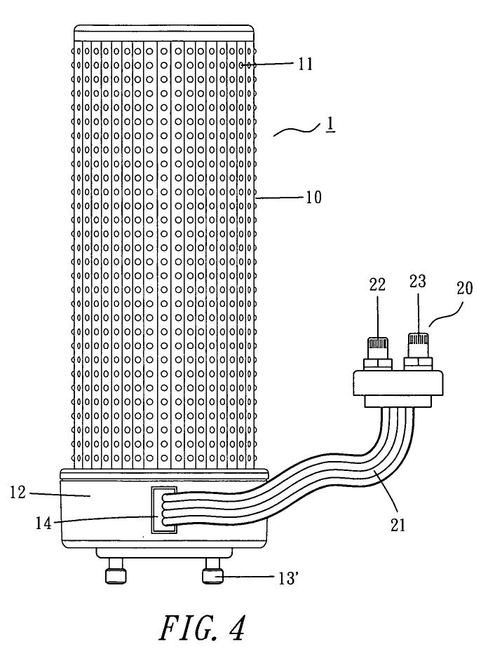

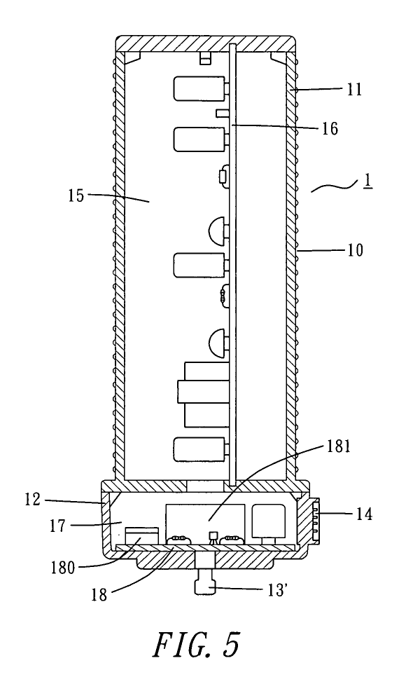

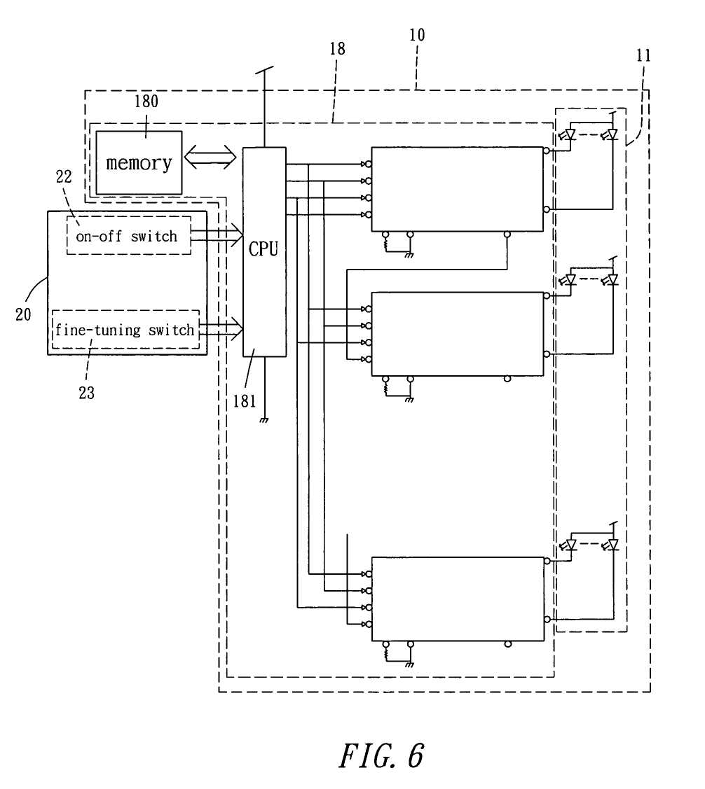

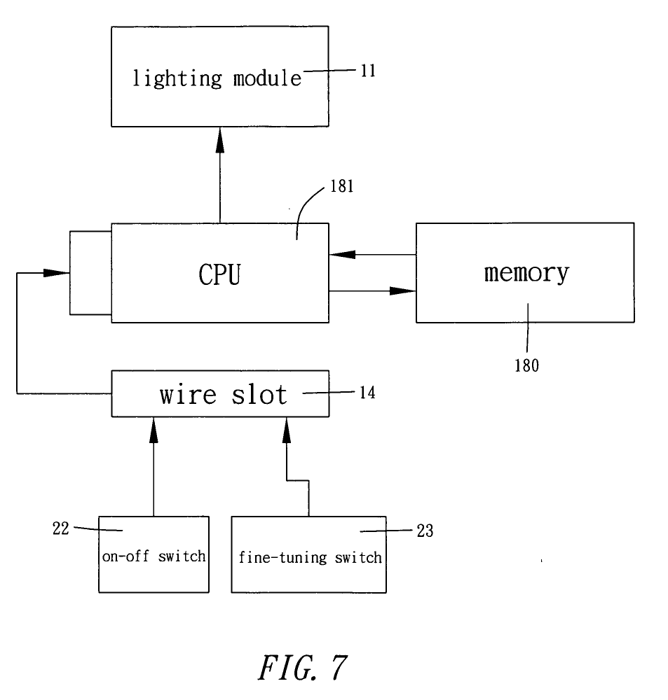

Referring to FIGS. 4 & 5, the multipurpose flame light 1 of the second exemplary embodiment of this invention is just the same as the first embodiment, which comprises a body 10, a lighting module 11, a base 12, a wire slot 14, a lodging space 15, a actuator circuits 16, another lodging space 17, a control system 18, a memory 180, a CPU 181, an ON-OFF control unit 20, a data line 21, a on-off switch 22 and a fine-tuning switch 23. On the other hand, the difference to the first embodiment is the downward extension below the base 12 for getting stuck with a lamp holder (not shown) is a set of shafted tie-ins 13′.

The multipurpose flame lights 1 of the first and the second exemplary embodiments of this invention have the same control system 18 (shown in FIGS. 6 & 7), where the CPU 181 is connected to the memory 180, the on-off switch 22 and the fine-tuning switch 23 of the ON-OFF control unit 20, and the lighting module 11 respectively. During the use, by turning the on-off switch 22, a selection of this invention to be used as flame-light mode or as illumination-light mode can thus be controlled, which means the program for using as flame-light mode and the program for using as illumination-light mode are stored in the memory 180. Therefore, by turning the on-off switch 22, the CPU 181 will issue the selection to access the program for the use as flame-light mode or the program for the use as illumination-light mode. And further processed by the CPU, the lighting module 11 on the body 10 lightens either as a flame light or an illumination light. By turning the fine-tuning switch 23, an augment or reduction of luminance of this invention can thus be controlled, where the programs of various flame shapes in the flame-light mode are stored in the memory 180. Therefore, by turning the fine-tuning switch 23, the CPU will issue the selection to access the program of the intended flame shape in the flame-light mode. And further processed by the CPU, the lighting module 11 on the body 10 lightens according to the lightening sequences in the program of various flame shapes and the augmented or reduced luminance is presented, which means the turning of the fine-tuning switch 23 is to control the changing of luminance of this invention. The number of the fine-tuning switch 23 can be more than one. If the number is “two”, which means the “augment” and the “reduction” are in separate control.

This invention exhibits abundant colors by the use of dithering of color, followed by the processing by the CPU 181, and its output is stored in the memory 180, for the precise control of the illumination of the lighting module 11 at different stage and different time. By adjusting each displaying or working time of the lighting module 11 with applying the pulse principle, the luminance and displayed colors of the lighting module 11 are then under control. By means of the ordered arrangement of the lighting module 11, the effects of dynamic flaming and illumination can be exhibited. Through the turning of the fine-tuning switch 23, a signal representing the specific amount of turning control is sent to the CPU 181, and is compared with the stored signals to adjust the electric current, which enables the adjustment of the luminance (from bright to dim or from dim to bright) of the lighting module 11 to the desired extent.

Accordingly, this invention features the following advantages and functions:
1.) The selection for using either as a flame light or as an illumination light is controlled directly from outside and the use features multiple purposes.
2.) Since the lighting module 11 of the body 10 is formed by a neat and ordered array of multiple LED lamps, the use as the flame light can thus offer the flaming a vivid and intensely dynamic effect.
3.) The ON-OFF control unit 20 connected to the base 12 of the body 10 is able to directly control the selection of the use as the flame light or as the illumination light. And the luminance of the flame light is capable of being adjusted anytime, which is terribly handy.

To sum up, the present invention is absolutely able to accomplish the expected objects and functions, and the detailed description is complete enough for those skilled in the art to realize the invention; however, the aforesaid exemplified embodiments of the present invention are only used for describing this invention. Any equivalent embodiments or modifications without departing from the spirit and scope of the present invention are therefore intended to be embraced.

What is claimed is:

1. A multipurpose flame light, made up of a body and an ON-OFF control unit, where the body is formed by a lighting module of a neat and ordered array of multiple LED lamps and an actuator for offering stable electric voltage and current to the lighting module, and the body being provided with a base at its bottom and a wire slot at its one side, where the base is further provided with a control system therein, which comprises a memory and a CPU; the ON-OFF control unit being connected to the control system through a data line passing through the wire slot, and the ON-OFF control unit further comprising an on-off switch and a fine-tuning switch; by turning the on-off switch, the lighting module being controlled by the control system to switch between flame-light mode and illumination-light mode, and by turning the fine-tuning switch, the multiple LED lamps of the lighting module being controlled by the control system to execute various lightening sequences that are programmed beforehand or to adjust the intended luminance.

2. A multipurpose flame light as in claim 1 wherein by turning the on-off switch, the lighting module being controlled by the control system to switch between flame-light mode and illumination-light mode, where the program for using as flame-light mode or the program for using as illumination-light mode is stored in the memory; therefore, by turning the on-off switch, a selection to access the program for using as flame-light mode or the program for using as illumination-light mode being executed, and further processed by the CPU, the lighting module on the body lightening according to the commands of the stored programs.

3. A multipurpose flame light as in claim 1 wherein by turning the fine-tuning switch, the multiple LED lamps of the lighting module being controlled by the control system to execute various lightening sequences that are programmed beforehand or to adjust the intended luminance, where the programs of various flame shapes in the flame-light mode are stored in the memory; therefore, by turning the fine-tuning switch, a selection to access the program of the intended flame shape in the flame-light mode being executed, and further processed by the CPU, the lighting module on the body lightening according to the lightening sequence in the program of various flame shapes and to the intended luminance.

4. A multipurpose flame light as in claim 1 wherein the base extends downward and a tie-in being set up thereon.

5. A multipurpose flame light as in claim 4 wherein the tie-in is a threaded one, for threaded connection with a lamp holder.

6. A multipurpose flame light as in claim 4 wherein the tie-in is a shafted one, for getting stuck with a lamp holder.
